(19) United States
(12) Patent Application Publication
(10) Pub. No.: US 2007/0138158 A1
(43) Pub. Date: Jun. 21, 2007

(54) Steel mesh welding stock rack

(76) Inventor: Steven B. Young, Azle, TX (US)

Correspondence Address: GUY V. MANNING, 1407 TEXAS STREET, SUITE 102, FORT WORTH, TX, 76102, US

(21) Appl. No.: 11/314,491

(22) Filed: Dec. 21, 2005

(51) Int. Cl. B23K 9/00

(52) U.S. Cl. 219/158

(57) ABSTRACT

A welding stock storage rack made from wire mesh bent to form a pyramid has a trapezoidal cross section and planar, vertical ends. The wire mesh comprises elongate strands of steel wire laid in a rectangular grid and welded at each intersection to form a panel of regular, individual cells. Additional wire mesh forms end panels, completing a geometrically stable, three-dimensional structure. Welding stock of various types and sizes may be inserted longitudinally, transversely or both through the pyramid to be supported horizontally at various levels above the floor by opposing cells. Several of the racks may be concatenated end to end to form a longer rack for lengthier welding stock, and the racks may be nested when empty for inventorying, storage and transportation.

### BACKGROUND OF THE INVENTION

1. Field of the Invention

This invention relates generally to welding supplies, and particularly to means of storing metal stock for use with welding activities. More particularly, this invention relates to a wire mesh welding stock rack adapted to store metal stock of various sizes in a compact and efficient manner.

2. Description of Related Art

Welders as a group are remarkably resourceful and capable of building many things from the simplest of metallic raw materials. Such raw materials include various lengths of bar, angle and channel stock and tubing they have on hand. Most welders are notorious for never throwing anything away, instead retaining remnants from earlier jobs in case they are needed for future ones. Such remnants can accumulate to the point that they become unmanageable, often simply piling up in an unused corner until what is on the bottom of the pile long since has been forgotten. Means for storing welding stock in an efficient manner which allows easy viewing and retrieval of available welding stock proves useful in even the smallest of welding shops.

Solutions for overcoming such chaos span a remarkable range of systems, including an array of bins, shelving and buckets for various sizes of welding stock. Most systems for lengthy welding stock involve heavy, often over-built shelves which are expensive even when fabricated from left-over stock, and which, once built, are so massive they are difficult to move or modify. For the smallest of shops, or for temporary job sites, such cumbersome and expensive systems are impractical. Simple, inexpensive, easily transported and stored, means for storing and accessing welding stock would be welcomed as a blessing by many welders.

### SUMMARY OF THE INVENTION

Accordingly, it is an object of this invention to provide means for storing welding stock or other items in an efficient and organized manner.

It is another object of this invention to provide means for storing welding stock or other items that is inexpensive to make or acquire.

It is another object of this invention to provide welding stock storage means that easily may be transported to and from temporary job sites.

It is yet another object of this invention to provide storage means for welding stock or other items that can be moved or relocated easily.

The foregoing and other objects of this invention are achieved by providing a welding stock storage rack made from wire mesh bent to form a pyramid having a trapezoidal cross section and planar, vertical ends. The wire mesh comprises elongate strands of steel wire laid in a rectangular grid and welded at each intersection to form a panel of regular, individual cells. Additional wire mesh forms end panels, completing a geometrically stable, three-dimensional structure. Welding stock of various types and sizes may be inserted longitudinally, transversely or both through the pyramid to be supported horizontally at various levels above the floor by opposing cells. Several of the racks may be concatenated end to end to form a longer rack for lengthier welding stock, and the racks may be nested when empty for inventorying, storage and transportation.

### BRIEF DESCRIPTION OF THE DRAWINGS

The novel features believed characteristic of the present invention are set forth in appended claims. The invention itself, however, as well as a preferred mode of use and further objects and advantages thereof, best will be understood by reference to the following detailed description of an illustrative embodiment when read in conjunction with the accompanying drawings, wherein:

FIG. 1 depicts in quartering perspective view a preferred embodiment of the present invention in use with welding stock.

FIG. 2 details in alternate quartering perspective the preferred embodiment of FIG. 1 without welding stock and dimensioned.

FIG. 3 details the present invention as depicted in FIG. 2 but longitudinally exploded to show its components.

FIG. 4 shows an alternate embodiment of the present invention.

FIGS. 5A, 5B detail the alternate embodiment of FIG. 4 in nested, storage configuration.

### DETAILED DESCRIPTION OF A PREFERRED EMBODIMENT

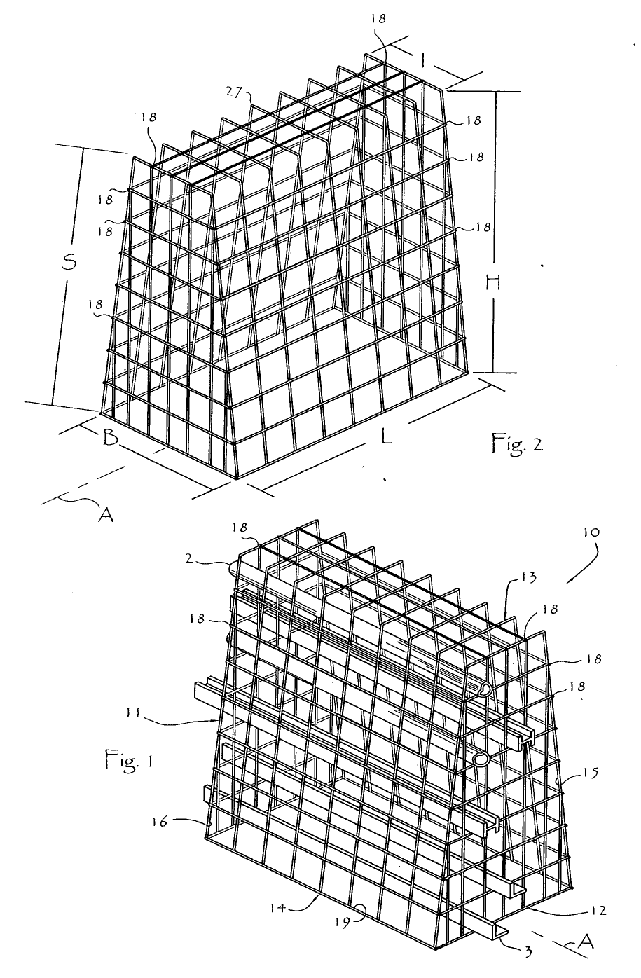

With reference now to the figures, and in particular to FIGS. 1 and 2, wire rack 10 of the preferred embodiment comprises a wire mesh pyramid having a longitudinal axis A and a trapezoidal transverse cross section having lower base width B and upper base width T. Sides 11 slope from rectangular bottom 14 a distance S to form the longitudinal edges of substantially flat top 13 at height H above bottom 14. Top 13 is substantially smaller than and parallel to bottom 14. Trapezoidal end panels 30 span between sides 11 from bottom 14 to top 13, thereby completing the pyramid. End panels 30 are welded solidly at each intersection point 18 with sides 11 and top 13, thereby securing and stabilizing of rack 10.

Sides 11, base 14, top 13 and end panels 30 surround hollow interior 19 open at bottom 14. As best seen in FIGS. 5A, 5B, interior 19 is adapted to receive top 13, sides 11 and end panels 30 of one or more additional racks 10 of similar size, thereby allowing them to be stacked for storage, transportation and inventory. As discussed in more detail below in conjunction with FIGS. 4, 5A and 5B, an alternate embodiment 50 of rack 10 comprises three similar pyramidal sections slightly different in longitudinal length to assure proper nesting.

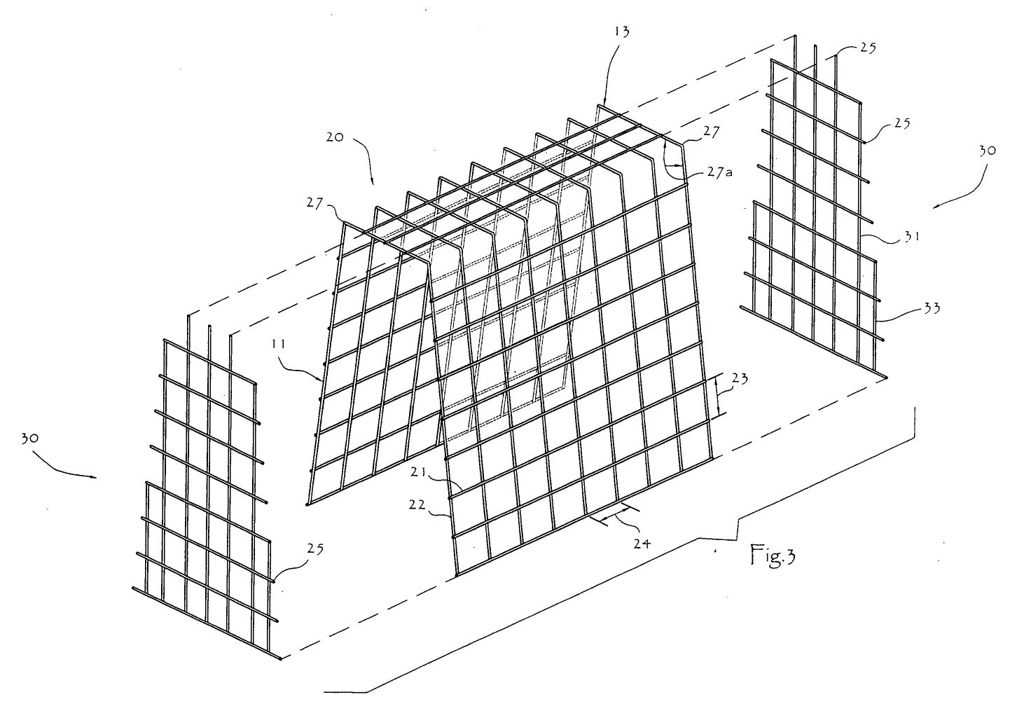

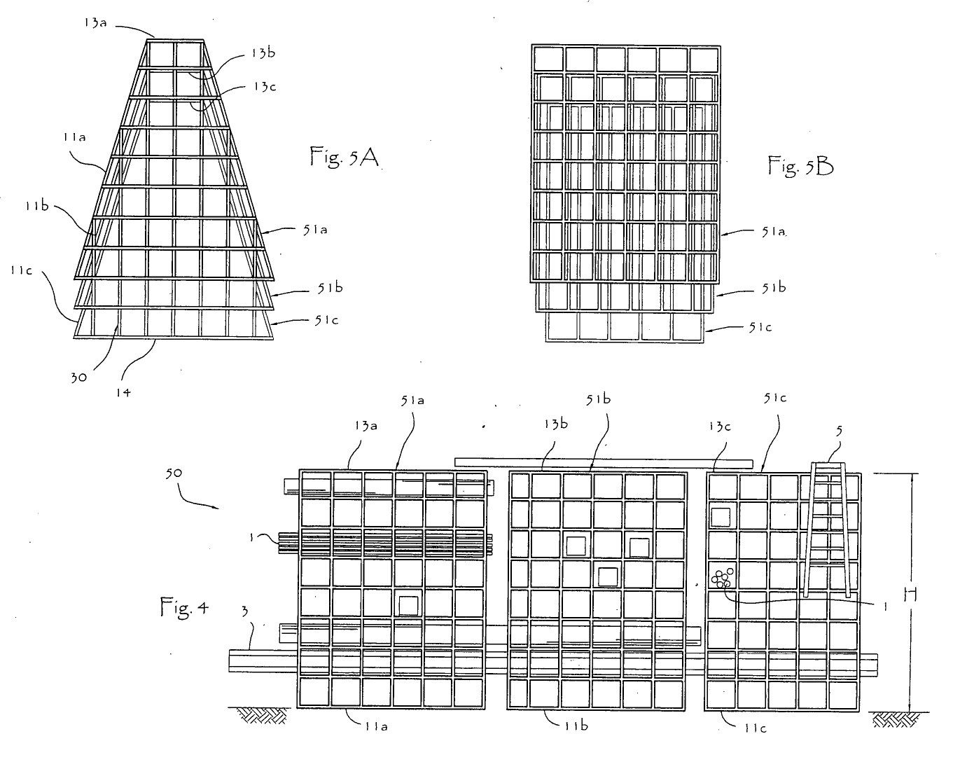

Referring now also to FIG. 3, rack 10 is fabricated from rectangular, wire mesh panel 20 comprising longitudinally arrayed wires 21 crossed at regular intervals by transverse wires 22. Wires 21, 22 attach to each other by welds at each of their common intersections, thereby creating a substantially planar, rectangular panel having rectangular openings, or cells 29. Two sets of corners 27 are formed in parallel sets of cells 29 along the longitudinal length of panel 20 and separated by transverse width T, thereby simultaneously forming top 13 and sides 11. Included angles 27A in corners 27 define the slope of sides 11 and thereby the relative sizes of top 13 and bottom 14. Included angles 27A are at least one hundred (100 deg.) degrees, and preferably one hundred fifteen (115 deg.) degrees, giving sides 11 a slope of approximately sixty five (65 deg.) degrees relative to bottom 14. At this configuration, sides 11 remain sufficiently upright to avoid a significant mismatch between cells 29 (discussed in detail below) of sides 11 and end panels 30 respectively. This also provides a wide enough base for rack 10 to prevent it from easily being tipped over by incidental bumping or jostling when loaded top heavy with welding stock 1. Specific dimensions of an example of the preferred embodiment are discussed in more detail below.

The relative spacing of longitudinal wires 21 and transverse wires 22 determines the size and shape of cells 29 and whether or not they are all equal in size along the length of panel 20. Preferably, cells 29 all are the same size and substantially larger than the cross section of the largest single piece of welding stock needed to be stored. For small diameter items such as reinforcing bar, cells 29 can be smaller than cells 29 intended to accommodate large angle iron 3 (FIG. 1). One having ordinary skill in the art will recognize that all such variations are considered to be within the spirit and scope of the present invention.

End panels 30 preferably are fabricated from portions of the same size and spacing of wire mesh comprising panel 20. In such case, substantial correspondence in size and elevation above bottom 14 occurs between cells 29 of panel 20 and end panels 30. This is desirable for a number of reasons. Ends 25 of longitudinal wires 21 of panel 20 and vertical and horizontal wires 31, 33 of end panels 30 meet readily and may be welded together. In the case where longitudinal wires 22 and vertical end panel 30 wires 33 meet, they form a continuous longitudinal arch paralleling axis A from one end of bottom 14, up each end panel 30 and along top 13. Likewise, where longitudinal wires 22 meet horizontal end panel 30 wires 31, they form continuous, horizontal “belts” surrounding rack 10 at a plurality of elevations above bottom 14, reinforcing the longitudinal arches and further strengthening rack 10 against any potential for bowing outward under load.

Just as importantly, when cells 29 in panel 20 and end panels 30 match, it is easier to insert welding stock 1 through opposing cells 29 so that it lays horizontally to avoid it sliding out of rack 10. As depicted in FIG. 1, longer pieces of welding stock 1 may extend between end panels 30 while shorter pieces of welding stock 1 may be inserted transverse to rack 10 between opposite cells 29 on opposite sides 11. Where cells 29 of sides 11 and end panels 30 are substantially the same size, it is much easier to insert stock along a given elevation than it would be if cells 29 were mis-matched in elevation or size.

Turning now also to FIG. 4, an alternate embodiment of the present invention comprises triple rack 50 having three separate sections 51a-51c, each constructed substantially as described above for rack 10. Sections 51a-51c differ from rack 10 mostly by the relative lengths sides of 11a-11c. As seen in FIGS. 5A, 5B, sections 51a-51c nest one inside the other for storage and transportation, occupying a nested volume barely larger than one rack 10. At the same time, sections 51a-51c stand precisely the same height H above the floor or other surface upon which they rest and their end panel 30 cells 29 align horizontally so that very lengthy welding stock 1 may be inserted longitudinally through end panels 30 of all three sections 51a-51c if such lengthy support is needed. Each of sections 51a-51c include two end panels 30 on opposite ends of sides 11a-11c respectively, so that shorter pieces of welding stock also may be inserted longitudinally and supported as in rack 10. A user aligns for usage sections 51a-51c in any order desired, but nests them as indicated in FIGS. 5A, 5B for transportation or storage.

To casual observance, sections 51a-51c each do not differ significantly from rack 10. Indeed, three or more racks 10 could be arrayed end-to-end with their longitudinal axes A aligned to achieve much the same goal as triple rack 50. If the nesting depicted in FIGS. 5A, 5B is desired for ease of storage or transportation, however, using three racks 10 is inferior to triple rack 50. This is because nesting three racks 10 of identical size can cause end panels 30 of the nested racks 10 to come into very tight contact. This can make them difficult to separate at times, such as if they have remained nested for a long time, e.g. in storage or inventory. Triple rack 50, however, avoids this problem by shortening each of sections 51b, 51c relative to section 51a. Thus, sides 11b are slightly shorter than sides 11a, and sides 11c are slightly shorter than sides 11b. This permits nesting of sections 51a-51c one inside the next without significant contact between their respective end panels 30. Preferably, sides 11b, 11c are two (2″) inch and four (4″) inches respectively shorter than sides 11a, providing approximately two inches of clearance between end panels 30.

This benefit comes at a price, of course. To achieve shortening of panels 20 of sections 51b, 51c requires narrowing panel 20 for each of those sections. Where panels 20 are fabricated for the purpose, only tooling changes are required when welding wires 21, 22. Where panels 20 are made from prefabricated cattle panel, however, as discussed below, it requires cutting off an entire transverse row of cells 29 for section 51c and shortening at least one transverse row of cells 29 on section 51b. This adds significantly to the trouble and cost of preparing panels 20 for sections 51b, 51c, a factor which makes it impractical for triple racks 50 which are rarely moved. Where racks 10 may be moved often, however, triple rack 50 may be preferable.

As mentioned above, rack 10 and triple rack 50 may be made using panels 20 fabricated from individual wires 21, 22, wherein variations in length L readily may be specified. Preferably, however, racks 10, 50 are constructed from prefabricated “cattle panel” readily available and used in constructing temporary and permanent fencing for cattle. Cattle panel sections typically are fifty-four (54″) inches (4½ feet) wide by sixteen (16′) feet long with cells 29 approximately eight (8″) inches wide by five (5″) inches high. Rack 10 may be made from two such cattle panels by using one for panel 20 and the other for both end panels 30. A detailed discussion of this process follows.

Panel 20 is fabricated by first measuring approximately one foot toward each end from the midpoint of one cattle panel to locate corners 27 (FIG. 3). Corners 27 then are bent into wires 22 at approximately 115 degrees (included angle 27a), thus placing the lower edges of sides 11 approximately the same distance apart as the 54″ height of a single cattle panel (length L). This makes height H of top 13 a little less than seven (7′) feet above bottom 14.

A second cattle panel then is cut approximately in half to begin fabrication of end panels 12. Each such proto-end panel 30 is stood across the ends of panel 20 with its prefabricated edge forming a transverse side of bottom 14, resulting in bottom 14 becoming a square with 54 inch sides. End panels 30 then are marked for cutting elsewhere or, preferably, cut in place, attention being given to maximize the matching of wires 31 with wires 21 where possible to create the horizontal “belts” discussed above. Perfect, one-to-one correspondence between wires 31,21 seldom occurs, because end panels 30 stand vertically (normal to bottom 14) while sides 11 slope at approximately sixty-five (65 deg.) degrees to bottom 14. Nevertheless, some will match up, and there will be one wire 31 for each wire 21 even when they do not meet end-to-end. All wires 31, 33 are welded to the edges of panel 20, and the excess from the cattle panel is trimmed off to complete rack 10.

Other heights H and pyramidal shapes for rack 10 may be constructed using the procedures above. For example, if two feet (approximately three cells 29) of the first cattle panel first are cut off, making panel 20 fourteen (14 ft.) feet long instead of sixteen feet, this causes corners 27 forming a two foot top 13 to fall very near a longitudinal wire 21, creating a longitudinal edge for top 13 (not shown). Using the same square bottom 14 resulting from spacing the lower, longitudinal edges of sides 11 the same distance apart, results in a height H for rack 10 of approximately six (6′) feet instead of seven feet. Obviously, reducing included angle 27a to less than stated above shortens the distance between the lower longitudinal edges of sides 11, makes rack 10 stand taller and reduces bottom 14 from a square of 54″ sides to a rectangle. One having ordinary skill in the art will recognize that all such variations are considered to be within the spirit and scope of the present invention.

Cattle panel typically comes in either one fourth (¼) inch or three sixteenths ( 3/16) inch gauge wires 21, 22. Preferably, end panels 30 are fabricated from the same gauge of cattle panel wire or from slightly lighter gauge wire. Where all wires 21, 22, 31, 33 are 3/16 gauge, rack 10 weighs only approximately thirty-five (35 lbs) pounds, and triple rack 50 weighs barely in excess of one hundred (100 lbs.) pounds. Thus, the present invention in either of its embodiments 10, 50 weighs no more than a reasonably strong person can lift and may be moved around easily by one person. Despite this lightness of weight, cells 29 may be filled entirely with solid welding stock without causing significant deformation of the pyramidal shape of racks 10, 50.

In operation, a user of rack 10 locates it on a level site, whether indoors or out, where easy access is available to sides 11 and end panels 30. There is no need to anchor it, as it is very heavy and stationary in most environments once loaded. As needed, the user inserts welding stock 1 of at least five foot length (for the preferred embodiment just described) through one end panel 30 cell 29 and through interior 19 to the corresponding cell 29 of opposite end panel 30. Welding stock 1 longer than five feet may protrude beyond end panels 30 as much as desired, until its ends sag unacceptably. Where welding stock I substantially exceeds five feet in length, a second or successive racks 10 may be disposed end-to-end with their longitudinal axes A aligned and a small gap between adjacent end panels 30. See FIG. 4. Lengthy welding stock 1 then may be inserted through as many end panels 30 as necessary to support them.

In like fashion, shorter welding stock 2 inserted transversely through cells 29 of opposite sides 11 may be of shorter length if placed close to top 13. Bulkier pieces which will not fit within cells 29 (i.e. with a cross sections of 5″ by 8″ or larger) may be laid on top 13 or hung on brackets (not shown) hooked into cells 29. Similarly, useful tools, such as ladder 5 (FIG. 4) may be hung onto racks 10, 50 as desired or convenient.

The present invention, described in either its preferred or alternate embodiment, thus serves to store welding stock 1 in vertically elevated planes which occupy much less territory than ordinarily required when laid out on the ground in stacks of like materials. One or more racks 10 may be employed in welding shops, yards or the like to keep permanent supplies of welding stock I handy and accessible. Where the present invention requires frequent relocation, such as a mobile welding truck storing significant quantities of welding stock 1, racks 10 prove to be so light in weight that they easily may be lifted and moved by one person. Where such welding stock 1 is expected to be lengthy, triple rack 50 may be preferable to multiple single racks 10 because sections 51a-51c nest and come apart more easily.

While the invention has been particularly shown and described with reference to one or more embodiments, it will be understood by those skilled in the art that various changes in form and detail may be made therein without departing from the spirit and scope of the invention. For example, while the present invention has been discussed above in the context of use with metal welding stock 1, it serves equally well for plumbing, electrical and carpentry supplies of plastic and metal pipe and wood, or in other fields, for example, for storage of elongated items used in non-building endeavors. Also, though discussed above in the context of large welding stock 1, miniature racks 10 could be used on a table or other platform (not shown) for storing small, elongate objects such as welding rods, pencils or the like.

I claim:

1. A welding stock rack adapted to receive and horizontally support elongate welding stock, the rack comprising an elongate body having:
a) a longitudinal length and a transverse width and bifurcated by a longitudinal axis;
b) a rectangular top disposed above and parallel to the base,
c) planar end panels disposed transverse the axis at opposite ends of the body and extending from the top to terminate in end panel bottom edges; and
d) planar, rectangular sides extending downward from the top on opposite sides of the axis to terminate in bottom edges, the coupled by their longitudinal ends to the end panels, the sides surrounding and defining a plurality of side openings adapted to receive the elongate welding stock.

2. The rack according to claim 1 wherein the sides further comprise
a) a plurality of longitudinal members disposed parallel to the axis;
b) a plurality of transverse members disposed substantially perpendicular to and coupled at their intersection points with the longitudinal members.

3. The rack according to claim 2 wherein the longitudinal and transverse members comprise steel wire welded at the intersection points.

4. The rack according to claim 1 wherein the longitudinal members are evenly spaced apart from the bottom edges of the sides to the top; the transverse members are evenly spaced apart between the end panels; and the longitudinal and transverse members define the side openings in matching pairs on opposite sides of the rack body.

5. The rack according to claim 1 wherein the end panels further comprise:
a) a plurality of horizontal members disposed transverse to the axis; and
b) a plurality of vertical members disposed substantially perpendicular to and coupled at their intersection points with the horizontal members, the horizontal and vertical members defining a plurality of end panel openings adapted to receive the elongate welding stock.

6. The rack according to claim 5 wherein the horizontal and vertical members comprise steel wire welded at the intersection points.

7. The rack according to claim 5 wherein the horizontal members are evenly spaced apart from the bottom end panel edges to the top; the vertical members are evenly spaced apart between the sides; and the horizontal and vertical members define paired end panel openings in matching pairs on opposite ends of the rack body.

8. The rack according to claim 1 wherein the sides further comprise:
a) a plurality of longitudinal members disposed parallel to the axis and evenly spaced apart from the bottom edges of the sides to the top; and
b) a plurality of transverse members disposed substantially perpendicular to and coupled at their intersection points with the longitudinal members; wherein the longitudinal and transverse members define the side openings in matching pairs on opposite sides of the rack body; and the end panels further comprise:
a) a plurality of horizontal members disposed transverse to the axis and evenly spaced apart from the bottom end panel edges of the sides to the top; and
b) a plurality of vertical members disposed substantially perpendicular to and evenly spaced apart between the sides, the vertical members coupled at their intersection points with the horizontal members, the horizontal and vertical members defining a plurality of end panel openings adapted to receive the elongate welding stock; and wherein the horizontal and vertical members define paired end panel openings in matching pairs on opposite ends of the rack body.

9. The rack according to claim 8 wherein the side openings and the end openings are of substantially the same height and width and arrayed in a plurality of horizontal rows along the sides and across the end panels.

10. The rack according to claim 8 wherein the horizontal, vertical, longitudinal and transverse members comprise steel wire.

11. A construction material rack adapted to receive and horizontally support elongate construction materials, the rack comprising:
a) two rectangular side panels arrayed equidistant from and on opposite sides of a longitudinal axis and having bottom and top longitudinal side panel edges separated by opposing end side panel edges;
b) two trapezoidal end panels disposed transverse the axis and coupled at their end panel sides to the end edges of the side panels, the end panels extending from end panel bottom edges coplanar with the bottom side panel edges to end panel top edges coplanar with the side panel top edges;
c) a horizontal, rectangular top panel extending longitudinally between and coupled to the end panel top edges and extending transversely between and coupled to the side panel top edges;
the side panels and end panels each surrounding and defining a plurality of apertures arrayed in a plurality of horizontal, paired rows on opposite sides and ends of the rack, the apertures adapted to receive and support the elongate construction materials.

12. The material rack according to claim 11 wherein:
a) the sides and top are fabricated from a single panel of rectangular wire mesh bent at selected angles to create longitudinal corners defining the top side edges and the top; and
b) the end panels are fabricated from a pair of rectangular wire mesh panels trimmed into a trapezoidal shape.

13. The material rack according to claim 12 wherein the apertures are defined by the intersection of individual horizontal and vertical wires in the wire mesh.

14. The material rack according to claim 12 wherein the wire mesh comprises prefabricated cattle panel having evenly spaced longitudinal and transverse steel wire members welded at their intersection points to define rectangular apertures arrayed in evenly spaced rows.

15. The material rack according to claim 11 and further comprising a plurality of additional racks arrayed with their longitudinal axes coaxial and adapted to receive and support elongate materials through the apertures in their respective end panels as necessary to support the elongate materials substantially horizontally.

16. The material rack according to claim 15 wherein each of the additional racks is adapted to nest one inside the other by inserting the tops of each additional rack into the open bottom of another rack.

17. The material rack according to claim 16 wherein each of the additional racks is longitudinally shorter than the rack into which it is nested.

18. An improved method of storing elongate materials, the method comprising
a) providing a rack having
i) two rectangular side panels arrayed on opposite sides of a longitudinal axis and having bottom, top and opposing end side panel edges;
ii) two trapezoidal end panels disposed transverse the axis and coupled at their end panel sides to the end side panel edges, the end panels having a lower base edge coplanar with the bottom side panel edges and an upper base edge coplanar with the side panel top edges;
iii) a horizontal, top panel coupled to the side panel top edges and the end panel upper base edges; and
iv) a plurality of apertures defined by the side panels and end panels and arrayed in a plurality of horizontal, paired rows on opposite sides and ends of the rack, the apertures adapted to receive and support the elongate construction materials; then
b) selecting a location for the rack having a horizontal platform and providing access to the side and end panels; then
c) selecting the elongate materials in groups of substantially equal length; then
d) inserting the elongate materials of each length into one or more of the apertures in the side and end panels and extending it through and interior of the rack to a corresponding aperture in the opposite side or end panel having a similar elevation; then
e) selecting elongate materials from the stored elongate materials as needed for construction.

19. An improved method of fabricating a storage rack for elongate materials, the method comprising
providing a panel of wire mesh, the panel having
a plurality of horizontal members spaced apart one from another a first selected distance;
a plurality of vertical members spaced apart a second spaced distance and disposed perpendicular to the horizontal members, the horizontal and vertical members welded one to another at their intersection points to define a plurality of rows of rectangular apertures defined by the first and second selected distances;
disposing the wire mesh in a transverse position bifurcated by a longitudinal axis of the storage rack; then
bending longitudinal corners into the wire mesh equidistant on either side of the axis to define a top of the storage rack elevated above a resting surface by two congruent, rectangular side panels having end edges; then
selecting a second panel of wire mesh; then
disposing the second wire mesh panel across the end edges of the side panels to define end panels one opposite ends of the storage rack; then
trimming the second wire mesh panels into a substantially trapezoidal shape and coupling them to the end edges.
